(19) United States
(12) Patent Application Publication
(10) Pub. No.: US 2014/0253389 A1
(43) Pub. Date: Sep. 11, 2014

(54) RANGING USING WI-FI AND ULTRASOUND MEASUREMENTS COMMUNICATION

(71) Applicant: QUALCOMM INCORPORATED, San Diego, CA (US)

(72) Inventor: Stephen J. Beauregard, San Jose, CA (US)

(73) Assignee: QUALCOMM INCORPORATED, San Diego, CA (US)

(21) Appl. No.: 13/791,853

(22) Filed: Mar. 8, 2013

(51) Int. Cl. G01S 5/02

(52) U.S. Cl. CPC G01S 5/02; G01S 2205/008
USPC 342/458

(57) ABSTRACT

System and methods are disclosed to use ultrasonic (US) and WiFi signals to improve range determination between devices in WiFi-based position or range estimation systems. Such systems may leverage existing WiFi infrastructure and US-capable sensors such as speakers and microphones as US transducers. US ranging between devices may be performed using round-trip time (RTT) or one-way measurements. To enable US ranging between a device and multiple US transmitters simultaneously, the US signal from each US transmitters or from the device may be modulated with a unique pseudo-random number (PRN) using direct sequence spread spectrum (DSSS). The transmission of US signals may be synchronized with the transmission of WiFi beacons which may contain data fields that contain the PRN sequence used to modulate the synchronous US signal. In RTT ranging, a receiving device receiving an US signal transmission may respond with its own PRN-modulated US signal synchronized to its WiFi beacon.

### BACKGROUND

This application generally relates to communication systems. In particular, this application relates to methods and systems for estimating the range to, or the position of, a WiFi-enabled communication device.

Many services and applications require knowledge of a position of mobile devices such as smartphones. While GPS receivers have been fairly successful in providing a low-cost solution for position determination, GPS receivers suffer from drawbacks such as severe attenuation of satellite GPS signals when the receivers are operated indoor. With the prevalence of WiFi networks, WiFi signals have increasingly been used to provide positional information of WiFi-enabled devices. WiFi signals have also been used to estimate range between WiFi devices, for example, in gaming applications to determine a distance between a game controller and a console.

In conventional WiFi-based position or range estimation systems, a mobile device may measure the strength of received WiFi signals such as through a received signal strength indication (RSSI) to estimate a range to another device. Alternatively, a mobile device may measure the elapsed time between transmission of a request-to-send (RTS) signal and reception of a clear-to-send (CTS) signal based on the WiFi RTS/CTS exchange to estimate a round-trip time (RTT), and hence a range to a responding device. The measured RTT is typically adjusted for the expected short inter-frame space (SIFS) of the responding device to compensate for the delay in the generation of the CTS signal. The mobile device may measure the RSSI and/or the SIFS-corrected RTT with respective to three or more APs to estimate the range of the mobile device to the APs. The mobile device may then use techniques such as trilateration or particle filters to estimate the position of the mobile device.

While WiFi-based position or range estimation systems may be relatively easy to implement, both types of WiFi measurements suffer from errors and distortions. For example, in the case RSSI measurements, multipath, transmit power variation, and receiver gain may affect the reported RSSI, and hence the estimated range or position. In the case of SIFS-corrected RTT measurements, calibrations of SIFS and other processing delays at either of the two endpoints, first-time-of-arrival detection thresholds, and peak detection algorithms may affect the reported RTT and the estimated range or position. In addition, the time resolution for the RTT measurements may be limited by the granularity of the MAC processor clock or the sampling clock operating on the WiFi signals. As such, there is a need for a low-cost solution to improve the accuracy of range measurements between WiFi devices for WiFi-based position or range estimation systems.

### BRIEF SUMMARY

System and methods are disclosed to use ultrasonic (US) and WiFi signals to improve range determination between devices in WiFi-based position or range estimation systems. Such systems may leverage existing WiFi infrastructure and US-capable sensors already enabled on WiFi devices such as smartphones to provide a low-cost, easily-deployable solution to improve the accuracy of range measurements and hence the position of mobile devices. For example, many speakers and microphones used in smartphones are capable of operating above the human-audible range (i.e., ˜15 KHz) in the US frequency. Mobile devices may use these speakers and microphones as inexpensive US transducers to generate and receive US signals without requiring additional sensors.

The advantage of US ranging is that the speed of sound is many orders of magnitudes slower than that of radio waves. As such, it is relatively easy to accurately measure the travel time of US signals between devices using low-sampling rate audio methods. In addition, US ranging results are very accurate (on the order of 10 cm or less) when the two endpoints are in short-range of each other and in line-of-sight (LOS). In contrast, WiFi-based ranging results based on RTT measurements of RF WiFi signals are prone to inaccuracies introduced by the granularity of the MAC clock or sampling clock. US ranging results may also be used to obtain a more accurate estimate of the SIFS to improve the WiFi-based RTT measurement.

Even for devices in non-LOS (NLOS) topologies or in longer range situations, US ranging may be used to improve WiFi-based range measurements. In these situations, an US signal in the direct path may experience significant attenuation and there may be multiple strong reflections in the non-direct paths. However, these multi-path reflections of an US signal are generally more distinguishable and hence are more easily detectable than are the multi-path reflections of an RF WiFi signal in the same environment. Therefore, the detection of US signals may be used to adjust the first-time-of-arrival (FTOA) detection threshold of RF signals in WiFi-based RTT measurements to improve the range estimate. In addition, RF and US noise are uncorrelated, making it possible to select a much lower FTOA detection threshold for the combined likelihood of the two modalities to increase sensitivity of detection without increasing the probability of false-detects.

A method for using US and WiFi signals for making range measurements between devices is disclosed. The method includes transmitting a first WiFi signal and a first US signal from a first device, where the first US signal is synchronized with the first WiFi signal. The method also includes receiving by the first device a second WiFi signal from a second device. The method further includes receiving by the first device a second US signal from the second device using information from the second WiFi signal. The second US signal is generated by the second device in response to the first US signal. The method further includes determining a range between the first device and the second device based on the transmitting of the first US signal, the receiving of the second US signal, and the receiving of the second WiFi signal.

A method for using US and WiFi signals for making range measurements between devices is disclosed. The method includes receiving by a second device from a first device a US signal and a WiFi signal. The US signal is modulated with a PRN sequence unique to the first device. The transmission of the US signal from the first device is synchronized with the transmission of the WiFi signal from the first device. The method also includes estimating by the second device a time delay between when the second device receives the WiFi signal and when the second device receives the US signal. The method further includes determining a range between the first device and the second device from the time delay.

An apparatus for making range measurements between the apparatus and a device is disclosed. The apparatus includes a RF transceiver for transmitting and receiving WiFi signals, an UL transducer for transmitting and receiving US signals, a non-transitory memory used to store instructions, and one or more processors that read the instructions from the memory to execute the steps for making the range measurements. The steps include commanding the RF transceiver to transmit a first WiFi signal and the US transducer to transmit a first US signal. The transmissions of the first WiFi signal and the first US signal are synchronized. The steps also include using the RF transceiver to receive a second WiFi signal from the device. The steps also include using the US transducer to receive a second US signal from the device. The second US signal is transmitted from the device in response to the device receiving the first US signal. The steps further include detecting the second US signal using information from the second WiFi signal. The steps further include determining a range between the apparatus and the device based on the transmitting of the first US signal, the receiving of the second US signal, and the receiving of the second WiFi signal.

An apparatus for making range measurements between the apparatus and a device is disclosed. The apparatus includes a RF transceiver for transmitting and receiving WiFi signals, an UL transducer for transmitting and receiving US signals, a non-transitory memory used to store instructions, and one or more processors that read the instructions from the memory to execute the steps for making the range measurements. The steps include using the US transducer to receive a first US signal from the device. The first US signal is modulated with a PRN sequence unique to the device. The steps also include using the RF transceiver to receive a first WiFi signal from the device. The transmission of the US signal is synchronized with the transmission of the WiFi signal from the device. The steps further include estimating by the apparatus a time delay between when the apparatus receives the WiFi signal and when the apparatus receives the US signal. The steps further include determining a range between the apparatus and the device from the time delay.

A system for making range measurements between the system and a device is disclosed. The system includes means for transmitting a first WiFi signal and a first US signal. The transmissions of the first WiFi signal and the first US signal are synchronized. The system also includes means for receiving a second WiFi signal from the device. The system further includes means for receiving a second US signal from the device using information from the second WiFi signal. The second US signal is transmitted from the device in response to the device receiving the first US signal. The system further includes means for determining a range between the system and the device based on the transmitting of the first US signal, the receiving of the second US signal, and the receiving of the second WiFi signal.

A system for making range measurements between the system and a device is disclosed. The system includes means for receiving a first US signal from the device. The first US signal is modulated with a PRN sequence unique to the device. The system also includes means for receiving a first WiFi signal from the device. The transmission of the US signal is synchronized with the transmission of the WiFi signal from the device. The system further includes means for estimating a time delay between when the system receives the WiFi signal and when the system receives the US signal. The system further includes means for determining a range between the system and the device from the time delay.

A non-transitory computer-readable medium that contains instructions for execution by one or more processors is disclosed. The processors execute the instructions to perform steps for making range measurements between devices. The steps include transmitting a first WiFi signal and a first US signal from a first device, where the first US signal is synchronized with the first WiFi signal. The steps also include receiving by the first device a second WiFi signal from a second device. The steps further include receiving by the first device a second US signal from the second device using information from the second WiFi signal. The second US signal is generated by the second device in response to the first US signal. The steps further include determining a range between the first device and the second device based on the transmitting of the first US signal, the receiving of the second US signal, and the receiving of the second WiFi signal.

A non-transitory computer-readable medium that contains instructions for execution by one or more processors is disclosed. The processors execute the instructions to perform steps for making range measurements between devices. The steps include receiving by a second device from a first device a US signal and a WiFi signal. The US signal is modulated with a PRN sequence unique to the first device. The transmission of the US signal from the first device is synchronized with the transmission of the WiFi signal from the first device. The steps also include estimating by the second device a time delay between when the second device receives the WiFi signal and when the second device receives the US signal. The steps further include determining a range between the first device and the second device from the time delay.

### BRIEF DESCRIPTION OF THE DRAWINGS

FIG. 1 shows a WiFi-based ranging measurement system that is aided by US ranging according to one or more embodiments of the present disclosure;

FIG. 2 shows the steps for deploying US ranging in a WiFi network-based position measurement system for APs of the WiFi network to determine a range to a mobile device of FIG. 1 according to one or more embodiments of the present disclosure;

FIG. 3 shows the steps for deploying US ranging in a WiFi mobile-based measurement determination system for a mobile device to determine a range of the mobile device to multiple APs according to one or more embodiments of the present disclosure;

FIG. 4 shows the steps for deploying peer-to-peer US ranging in a WiFi network to determine a range between two devices, such as between a mobile device and an AP, or between a game console and a game controller according to one or more embodiments of the present disclosure; and

FIG. 5 shows a block diagram of a WiFi-enabled device with US transducers such as that found in an AP or a mobile device according to one or more embodiments of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed to use US (ultrasonic) and WiFi signals to estimate the range between WiFi-enabled devices or to estimate the position of WiFi-enabled mobile devices in WiFi networks. The devices in the WiFi networks may leverage US-capable sensors already existing on the devices. For example, many speakers and microphones used in smartphone are capable of operating as US transducers to generate and receive signals above the human-audible range in the US frequency. APs (access point) in WiFi networks may also be fitted easily with US transducers if they don't exist already. In addition, transducer arrays may be installed to provide directional capability such as Tx (transmit) beam forming and/or Rx (receive) DOA (direction-of-arrival) estimation on WiFi devices.

US ranging between devices may be performed using RTT or one-way measurements. To enable US ranging between a device and multiple US transmitters simultaneously, e.g., between a mobile device and multiple APs, the US signal from each AP or the mobile device may be modulated with a unique pseudo-random number (PRN) using direct sequence spread spectrum (DSSS). In other embodiments, the US signal may be modulated with PRN using chirp spread spectrum. The transmission of US signals from a device may be synchronized with the transmission of WiFi beacons from that device. The WiFi beacon may have data fields that contain the PRN sequence used to modulate the synchronous US signal. The receiving device may correlate received US signals with a local copy of the PRN sequence to detect the US signals.

In one-way ranging, a receiving device may measure the difference in the time of arrival of the RF WiFi beacon and the slower US signal from a transmitting device to estimate the range between the two devices. In RTT ranging, a receiving device receiving an US signal transmission from an originating device may respond with its own PRN-modulated US signal synchronized to its WiFi beacon. The originating device may measure the RTT as the time between the transmission of its US signal and the reception of the US signal from the receiving device to estimate the range between the two devices. In RTT ranging, the originating device may be either the mobile device or the AP. Position determination of a mobile device may be made by knowing the position of a multitude of APs and the range measurements from each of the APs to the mobile device.

US ranging may be made in conjunction with WiFi-based RTT measurements using the CTS/RTS, QoS (quality of service) acknowledgement, 802.11 immediate acknowledgement, or other types of exchanges. For example, US-based RTT measurement may be used to improve the WiFi-based RTT measurement, such as to obtain a more accurate estimate of the SIFS of the CTS/RTS exchange. In one or more embodiments, a device may use the more detectable multi-path reflection of an US signal in a NLOS environment to adjust the FTOA detection threshold for the RF WiFi signal to improve the WiFi-based RTT measurement. In other embodiments, US-based RTT measurements may be used to improve WiFi-based RSSI measurements. For example, US-based measurements may be used to calibrate the effects of multipath and transmit power variations on the RSSI measurements.

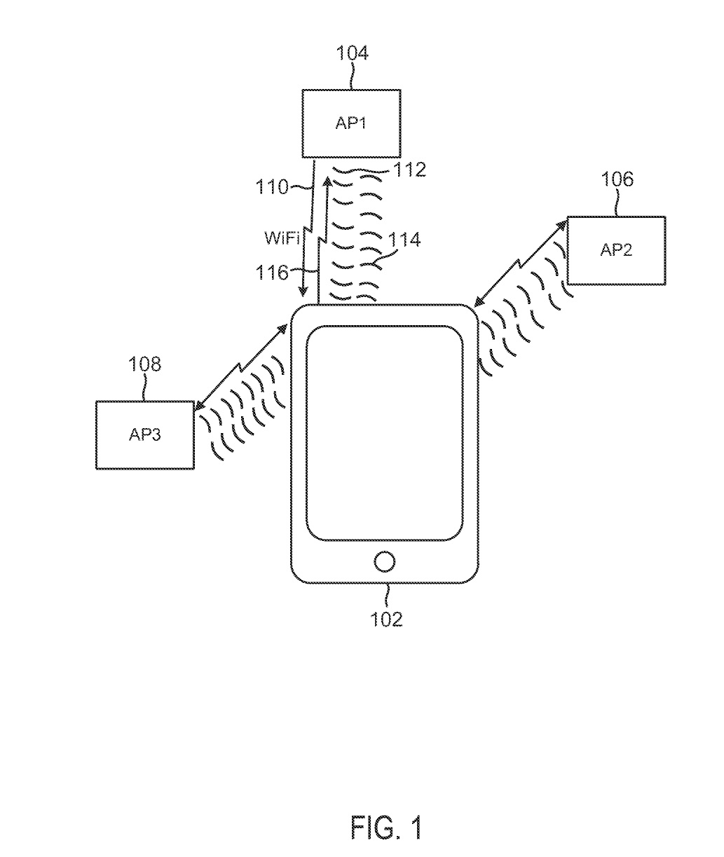

FIG. 1 shows a WiFi-based ranging measurement system that is aided by US ranging according to one or more embodiments of the present disclosure. A mobile device 102 is within WiFi range of three APs—AP1 104, AP2 106, and AP3 108. The APs may have US-capable sensors, such as existing speakers and/or microphones. Similarly, mobile device 102 may have speakers and microphones that may transmit and receive US signals. In one or more embodiments, each AP may be fitted with an US transducer or an array of US transducers to provide directional capability, such as US Tx beam forming and/or Rx DOA estimation.

The APs may be part of the same WiFi network or may belong to different WiFi networks. To measure the range from the APs to mobile device 102, each AP may transmit an RF WiFi beacon that is synchronized with an US transmission. For example, AP1 104 may synchronize the start of transmission of a WiFi beacon 110 with the start of transmission of its US signal 112. In one or more embodiments, AP1 104 may transmit WiFi beacon 110 to broadcast its WiFi capability at a rate of 10 Hz and may synchronize the transmission of US signal 112 with every 10th WiFi beacon to achieve an US transmission rate of 1 Hz. In one or more embodiments, AP1 104 may synchronize the transmission of US signal 112 with other types of WiFi transmissions.

To enable US ranging between the APs and mobile device 102 simultaneously, the US signal from each AP may be modulated with a unique pseudo-random number (PRN) using direct sequence spread spectrum (DSSS) or chirp spread spectrum. The PRN may repeat with a period comprising of a certain number of codes, referred to as chips. In one or more embodiments, APs may continuously transmit a train of PRN-modulated US signals. In one or more embodiments, APs may PRN modulate US signals on a message frame basis. WiFi beacon 110 may have data fields that contain the PRN sequence of AP1 104 used to modulate the synchronous US signal 112. The data fields from WiFi beacon 110 may also indicate if there is a synchronous US signal 112. Similarly, the WiFi beacons from AP2 106 and AP3 108 may have data fields that contain the PRN sequence used by the respective APs to modulate the synchronous US signals, and if necessary an indication of the presence of the synchronous US signal from the APs. In one or more embodiments, PRN sequences of the APs may be transmitted in data packets contained in WiFi transmissions other than WiFi beacons.

Mobile device 102 may receive a composite US signal comprising of US signals from multiple APs simultaneously. Mobile device 102 may select an US signal from a particular AP for detection by correlating the composite US signal with a local copy of the PRN sequence specific to that AP. For example, mobile device 102 may correlate the composite US signal with a local copy of the PRN sequence for AP1 104 to detect US signal 112 from AP1 104. Because the speed of WiFi beacon 110 is many orders of magnitude faster than the speed of US signal 112, mobile device 102 receives WiFi beacon 110 ahead of US signal 112. As such, mobile device 102 may have sufficient time to decode the data in WiFi beacon 110 to obtain the PRN sequence of AP1 104 and to be alerted to the expected arrival of US signal 112.

Mobile device 102 may search for US signal 112 by correlating the composite US signal with different code phases of the decoded PRN sequence. The different codes phases may be generated by time shifting the PRN sequence by different number of chips, or fractions of chips. A code phase of the PRN sequence correlates with US signal 112 when US signal 112 as received by mobile device 102 is time aligned with the code phase of the PRN sequence. The correlation sum for the properly aligned PRN sequence accumulates until the correlation sum exceeds an US detection threshold. When this happens, a detection of US signal 112 may be declared. Mobile device 102 may select the US detection threshold to achieve a desired probability of detect without exceeding a maximum probability of false-detect of US signal 112. In NLOS environment, a direct-path US signal may be significantly attenuated with respect to multipath reflected US signals. Due to the relative slow speed of US signals, correlation sums for multipath-delayed code phases of the PRN sequence may be easily distinguished from the correlation sum for the direct-path code phase of the PRN sequence.

When mobile device 102 detects the FTOA of US signal 112, mobile device 102 may respond with a PRN-modulated US signal 114 of its own. The PRN-modulated US signal 114 may be synchronized with a WiFi beacon 116 from mobile device 102 in a similar fashion as the synchronization between US signal 112 and WiFi beacon 110 from AP1 104. Thus, WiFi beacon 116 from mobile device 102 may have data fields that contain the PRN sequence used by mobile device 102 to modulate the synchronous US signal 114. The data fields in WiFi beacon 116 may also indicate the presence of synchronous US signal 114 and/or that US signal 114 is transmitted in response to US signal 112 from AP1 104. In one or more embodiments, the PRN sequence of mobile device 102 may be transmitted in data packets contained in WiFi transmissions other than WiFi beacon 116. In one or more embodiments, WiFi beacon 116 may not be synchronized with US signal 114 as long as the PRN sequence of mobile device 102 is decoded in time for use by AP1 104 to search for US signal 114.

Similar to the US detection at mobile device 102, AP1 104 may correlate US signal 114 with different code phases of a local copy of the PRN sequence for mobile device 102. AP1 104 may decode the data in WiFi beacon 116 to obtain the PRN sequence of mobile device 102 and may be alerted to the expected arrival of US signal 114. The detection of US signal 114 may be declared when the correlation sum for the properly time-aligned code phase of the PRN sequence exceeds an US detection threshold. AP1 104 may estimate the US-based RTT between AP1 104 and mobile device 102 by measuring the time delay from the start of transmission of US signal 112 from AP1 104 to the detection of FTOA of US signal 114 from mobile device 102. The range between AP1 104 and mobile device 102 may be estimated as the product of the speed of the US signal multiplied by half of the US-based RTT measurement.

Similarly, to estimate the range between mobile device 102 and AP2 106, and between mobile device 102 and AP3 108, mobile device 102 may select an US signal from AP2 106 or AP3 108 for detection by correlating the composite US signal with different code phases of a local copy of the PRN sequence for AP2 106 or AP3 108. Mobile device 102 may decode the data in the WiFi beacons from AP2 106 or AP3 108 to obtain the PRN sequence for the respective APs. When there is a detection of US signal from either AP2 106 or AP3 108, mobile device 102 may similarly respond with its own PRN-modulated US signal synchronized with a WiFi beacon. AP2 106 or AP3 108 may estimate the US-based RTT between the APs and mobile device 102 by measuring the time delay from the start of transmission of its respective US signal to the detection of FTOA of the US signal from mobile device 102. In one or more embodiments, one of the APs may be designated as the master AP. The master AP may estimate the position of mobile device 102 using the known position of at least two APs and the estimated range between the APs and mobile device 102.

In addition to making the US-based RTT measurement, the APs may measure the WiFi-based RTT using the CTS/RTS exchange. For example, in conjunction with transmitting US signal 112 and WiFi beacon 110, AP1 104 may transmit a RTS frame to mobile device 102. In this regard, upon detecting the RTS frame from the AP, mobile device 102 may transmit the CTS frame back to the AP after a delay of SIFS. In one or more embodiments, the APs may use the US-based RTT measurement to improve the WiFi-based RTT measurement. For example, AP1 104 may use the US-based RTT measurement to obtain a more accurate estimate of the SIFS of mobile device 102. In one or more embodiments, after the SIFS calibration of mobile device 102, US ranging may no longer be needed to assist the WiFi-based RTT measurement to mobile device 102. In one or more embodiments, the APs may continue to use US ranging even after SIFS calibration. In this regard, the APs may use the more detectable US multipath signals to adjust the FTOA detection threshold for the RF WiFi signal to improve the WiFi-based RTT measurement in a NLOS environment. In one or more embodiments, the APs may make the WiFi-based RTT measurements using QoS acknowledgement, 802.11 immediate acknowledgement, or other types of exchanges.

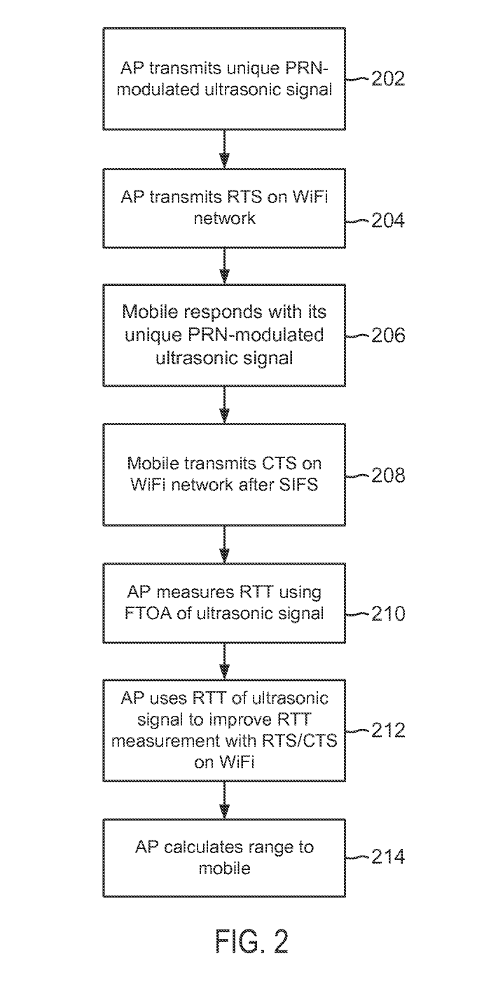

FIG. 2 shows the steps for deploying WiFi-based ranging aided by US ranging in a WiFi network-based position measurement system for APs of the WiFi network to determine a range to a mobile device of FIG. 1 according to one or more embodiments of the present disclosure. In the network-based position measurement system, one or more APs initiate the US and WiFi-based ranging measurement to a mobile device to estimate the range from the APs to the mobile device. One or more APs may also calculate the position of the mobile device based on the known position of the APs and the range measurements.

In 202, an AP of FIG. 1 transmits an US signal modulated with a PRN sequence unique to the AP. The transmission of the US signal from the AP may be synchronized with a WiFi beacon from the AP. The WiFi beacon may have data fields that contain the PRN sequence used to modulate the synchronous US signal. In 204, the AP transmits a RTS frame to mobile device 102 to measure the WiFi-based RTT using the CTS/RTS exchange.

In 206, mobile device 102 receives the WiFi beacon from the AP, demodulates the data, and obtains the PRN sequence for the AP. Mobile device 102 is also alerted by the data to the expected arrival of the US signal. To search for the US signal from the AP, mobile device 102 correlates a received US signal with different code phases of the PRN sequence for the AP. The range of the code phases of the PRN sequence over which to search for the US signal may be estimated from the maximum range of mobile device 102 from the AP. For example, mobile device 102 may estimate the maximum range from the AP based on knowledge of the maximum operating range of the AP of the WiFi network. In one or more embodiments, mobile device 102 may estimate the maximum range from the RSSI measurement. When the correlation sum for one of the code phases of the PRN sequence exceeds an US detection threshold, indicating that the one code phase is time aligned with the PRN sequence of the received US signal, the US signal is detected. In response, mobile device 102 transmits a US signal that is modulated with its own unique PRN. Mobile device 102 also synchronizes the transmission of the US signal with the transmission of a WiFi beacon. The WiFi beacon from mobile device 102 may have data fields that contain the PRN sequence used by mobile device 102 to modulate the synchronous US signal. In one or more embodiments, the WiFi beacon may not be synchronized with the US signal from mobile device 102 as long as the PRN sequence of mobile device 102 is decoded in time for use by the AP to search for the US signal from mobile device 102.

In 208, mobile device 102 receives the RTS frame from the AP. After a delay of SIFS, mobile device 102 transmits a CTS frame back to the AP. In 210, the AP receives the WiFi beacon from mobile device 102, demodulates the data in the WiFi beacon, and obtains the PRN sequence for mobile device 102. The AP is also alerted by the data to the expected arrival of the US signal from mobile device 102. To detect the US signal from mobile device 102, the AP correlates the received US signal with different code phases of the PRN sequence for mobile device 102. The AP estimates the US-based RTT between the AP and mobile device 102 by measuring the time delay from the start of transmission of the US signal from the AP to the detection of FTOA of the US signal from mobile device 102.

In 212, the AP receives the CTS frame from mobile device 102. To obtain a more accurate estimate of the SIFTS of mobile device 102 to improve the WiFi-based RTT measurement based on the CTS/RTS exchange, the AP uses the US-based RTT measurement. For example, the AP may use the US-based RTT measurement to estimate the expected WiFi-based RTT. The difference between the expected WiFi-based RTT and the measured WiFi-based RTT may be used to calibrate the SIFS. In 214, the AP calculates the range to mobile device 102 using the US-based RTT measurement or the SIFT-calibrated WiFi-based RTT measurement. In one or more embodiments, based on the range measurements of at least two APs to mobile device 102 and the known positions of the APs, one or more APs may also estimate the position of mobile device 102.

In one or more embodiments, US ranging measurement may be initiated from mobile device 102 to the APs. In this regard, the roles played by mobile device 102 and the AP in the steps of FIG. 2 may be switched. In one or more embodiments, mobile device 102 may receive a command from a master AP to start the ranging measurement. Mobile device 102 may align the transmission of a PRN-modulated US pulse with the transmission of a WiFi beacon. In conjunction with US ranging, mobile device 102 may transmit a WiFi RTS frame to make a WiFi-based RTT measurement using the CTS/RTS exchange. An AP may receive the US signal from the mobile device and may respond with an US signal modulated with a PRN of the AP. The AP may also transmit a CTS frame in response to the RTS after a delay of SIFS. Mobile device 102 may receive the US signal from the AP to estimate the US-based RTT, and may receive the CTS frame to estimate the WiFi-based RTT. Mobile device 102 may use the US-based RTT measurement to improve the WiFi-based RTT measurement.

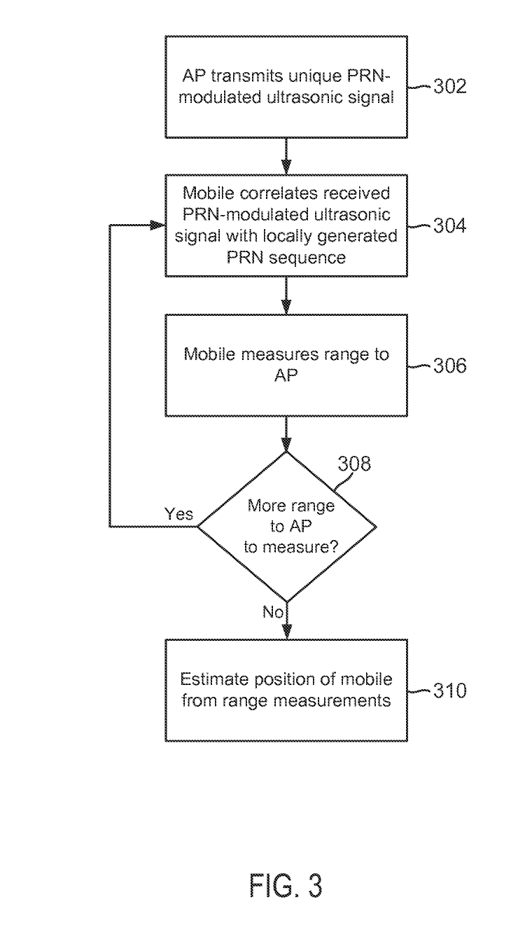

FIG. 3 shows the steps for deploying US ranging in a WiFi mobile-based measurement determination system for a mobile device to determine a range of the mobile device to multiple APs according to one or more embodiments of the present disclosure. In the mobile-based measurement system of FIG. 3, one or more APs originate an US signal to a mobile device for the mobile device to estimate the range from the mobile device to the APs based on one-way US-based range measurements.

In 302, an AP of FIG. 1 transmits an US signal modulated with a PRN sequence unique to the AP. As in 202 of FIG. 2, the transmission of the US signal from the AP may be synchronized with a WiFi beacon from the AP. The WiFi beacon may have data fields that contain the PRN sequence used to modulate the synchronous US signal. In one or more embodiments, the AP may synchronize the US signal with other types of WiFi transmission that have data packets containing the PRN sequence.

In 304, mobile device 102 receives the WiFi beacon from the AP, demodulates the data, obtains the PRN sequence for the AP, and is alerted to the expected arrival of the US signal. Mobile device 102 may record the FTOA of the WiFi beacon. To search for the US signal from the AP, mobile device 102 correlates a received US signal with different code phases of the PRN sequence for the AP. Mobile device 102 detects a FTOA of the US signal when the correlation sum for the earliest code phase of the PRN sequence exceeds an US detection threshold. Mobile device 102 may record the FTOA of the US signal. One advantage of using US signal as an aid to WiFi-based ranging is that the RF and US noises are uncorrelated, making it possible to select a lower FTOA detection threshold for the WiFi beacon to increase the sensitivity of detection without increasing the probability of false-detects. Even if NLOS environment, the detection of the more distinguishable multi-path reflections of the US signal may be used to adjust the first-time-of-arrival (FTOA) detection threshold of the WiFi beacon to improve the sensitivity of WiFi detection.

In 306, mobile device 102 measures the difference in the FTOA of the WiFi beacon and the FTOA of the US signal from the AP. From the time delay in the FTOA between the WiFi beacon and the US signal, and from knowledge of the speed of the RF WiFi beacon and the speed of the US signal, mobile device 102 may estimate the range to the AP. In 308, mobile device 102 determines if there are more range measurements to be made to other APs. Mobile device 102 may detect WiFi beacons from other APs and may determine from the data in the WiFi beacons if the WiFi beacons are synchronized with US signals. If there is an impending US signal from an AP not yet ranged, 304 and 306 are repeated to determine the range of mobile device 102 to the AP.

In 310, mobile device 102 may receive the positions of the APs for which mobile device 102 has range measurements. From the positions of at least two APs and the range measurements to the APs, mobile device 102 may estimate its position. In one or more embodiments, in addition to making range measurements based on the time delay in the FTOA between the WiFi beacon and the US signal, mobile device 102 may make RSSI measurements of the US signals from the APs. The US RSSI measurements from the APs may be used as a signature in a database to estimate the position of mobile device 102. In one or more embodiments, US-based range measurements may be used to calibrate the effects of multipath paths on the power of the received US signal to improve US RSSI measurements.

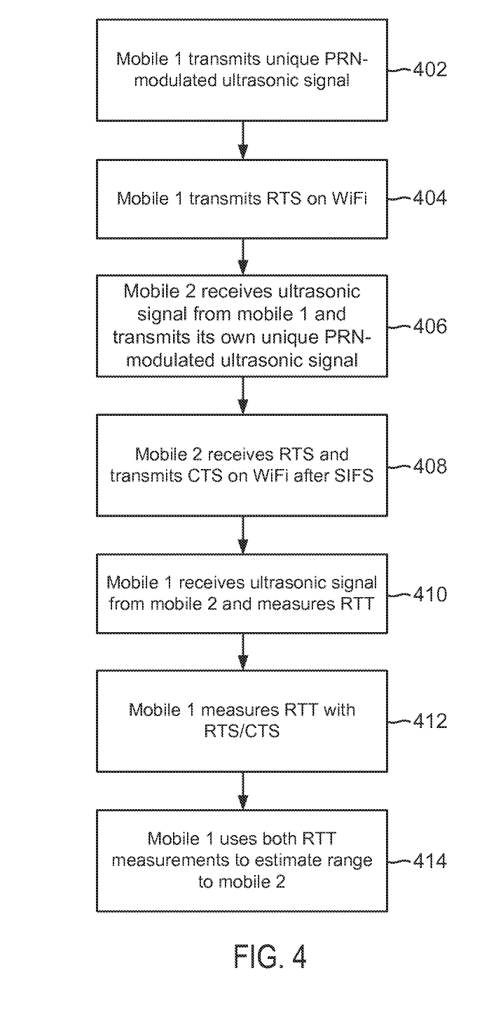

FIG. 4 shows the steps for deploying peer-to-peer US ranging in a WiFi network to determine a range between two devices, such as between a mobile device and an AP, or between a game console and a game controller according to one or more embodiments of the present disclosure. Other applications that may use peer-to-peer ranging include homing, fine-grained proximity detection, or ranging between APs in a mesh positioning system.

In 402, a first device transmits an US signal modulated with a PRN sequence unique to the first device. As in 202 of FIG. 2 or 302 of FIG. 3, the transmission of the US signal from the first device may be synchronized with a WiFi beacon from the first device. The WiFi beacon may have data fields that contain the PRN sequence used to modulate the synchronous US signal. In 404, the first device transmits a RTS frame to a second device to measure the WiFi-based RTT using the CTS/RTS exchange.

In 406, the second device receives the WiFi beacon from the first device, demodulates the PRN sequence for the first device, detects the US signal, and responds with its own PRN-modulated US signal. To search for the US signal from the first device, the second device correlates a received US signal with different code phases of the PRN sequence for the first device. The second device detects the US signal when the correlation sum for one of the code phases of the PRN sequence exceeds an US detection threshold. In response, the second device transmits an US signal that is modulated with its own unique PRN. The second device also synchronizes the US transmission with the transmission of a WiFi beacon. The WiFi beacon from the second device may have data fields that contain the PRN sequence used by the second device to modulate the synchronous US signal. In one or more embodiments, the US transmission and the WiFi beacon from the second device may not be synchronized.

In 408, the second device receives the RTS frame from the first device. After a delay of SIFS, the second device transmits a CTS frame back to the first device. In 410, the first device receives the WiFi beacon from the second device, demodulates the PRN sequence for the second device, and uses the PRN sequence to detect the US signal from the second device. To detect the US signal from the second device, the first device correlates a received US signal with different code phases of the PRN sequence for the second device until the correlation sum for one of the code phases exceeds an US detection threshold. The first device estimates the US-based RTT between the first device and the second device by measuring the time delay from the start of transmission of the US signal from the first device to the detection of FTOA of the US signal from the second device.

In 412, the first device receives the CTS frame from the second device. The first device measures the delay from the RTS frame to the CTS frame as the WiFi-based RTT. In 414, the first device uses the US-based RTT measurement and the WiFi-based RTT measurement to estimate the range to the second device. In one or more embodiments, the first device uses the US-based RTT measurement to improve the WiFi-based measurement. For example, to calibrate more accurately the SIFTS of the second device to improve the WiFi-based RTT measurement based on the CTS/RTS exchange, the first device may use the US-based RTT measurement to estimate the expected WiFi-based RTT. The difference between the expected WiFi-based RTT and the measured WiFi-based RTT may be used to calibrate the SIFS.

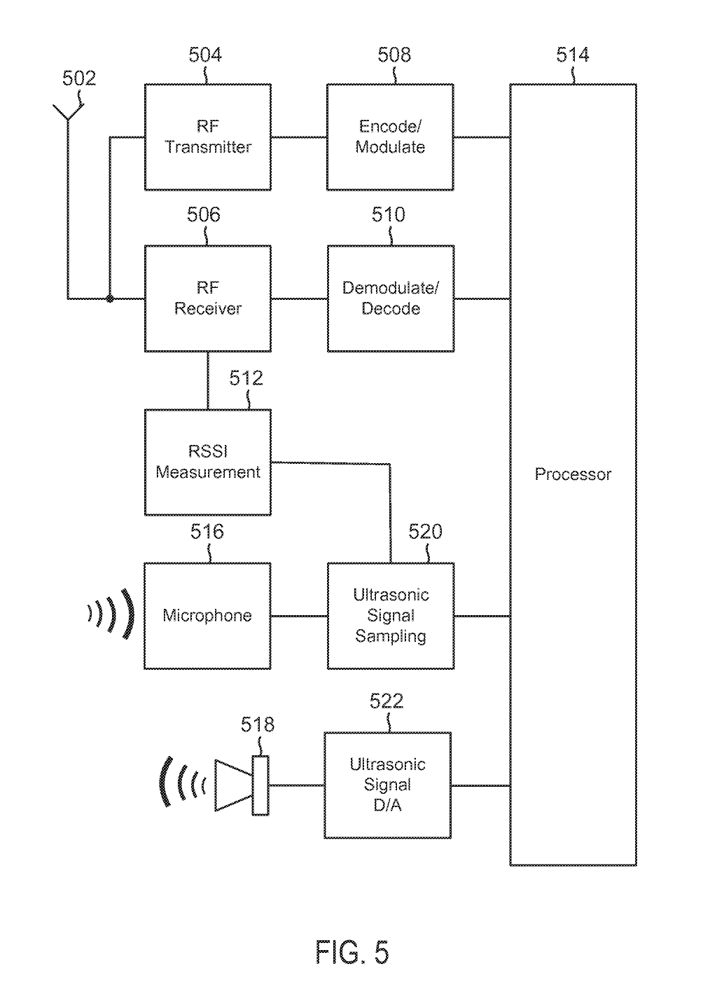

FIG. 5 shows a block diagram of a WiFi-enabled device with US transducers such as that found in an AP or a mobile device according to one or more embodiments of the present disclosure. An RF antenna 502 is used by the device to transmit or receive RF WiFi signal. RF antenna 502 may be an array of antennas to introduce directional capability such as Tx beam forming and/or Rx DOA estimation. RF antenna 502 may also have antenna diversity for interference avoidance.

An RF transmitter module 502 and an RF receiver module 506 transmit and receive WiFi signals through antenna 502. RF transmitter module 504 may up-convert baseband or IF (intermediate frequency signal) signal to the RF carrier frequency of the WiFi network and may amplify the RF signal to transmit the WiFi signal with a certain transmit power level. Conversely, RF receiver 506 may down-convert the RF carrier frequency of the received WiFi signal and may filter/amplify the signal to generate the baseband signal.

An encode/modulate module 508 performs the encoding and modulation of the transmit data to generate the WiFi baseband signal for RF transmitter module 504. For example, encode/modulate module 508 may perform the encoding and modulation of the data in the data fields of WiFi beacons. The data fields may contain the PRN sequence used to modulate US signals from the WiFi-enabled device. Similarly, a demodulate/decode module 510 performs the demodulation and decoding of the received WiFi baseband data from RF receiver 506. For example, demodulate/decode module 510 may perform the demodulation and decoding of the data in received WiFi beacons to obtain the decoded PRN sequence used to correlate with the incoming PRN-modulated US signal for detecting the US signal. A RSSI measurement module 512 measures the RSSI of the received WiFi signal or the received US signal as an aid to ranging measurements.

A processor 514 controls the operation of the device, including the operation to Tx/Rx WiFi and US signals. Processor 514 may include a micro-controller, digital signal processor (DSP), or other processing components. Processor 514 may perform specific operations by executing one or more sequences of instructions contained in a system memory.

A microphone 516 and a speaker 518 are used as part of an US transducer to receive and transmit US signal, respectively. In one or more embodiments, an array of microphones and speakers may be used as a transducer array to provide directional US capability such as US Tx beam forming and/or US Rx DOA estimation.

An ultrasonic signal sampling unit 520 filters and samples the received PRN-modulated US signal at a high enough sampling rate to down-convert the US signal to recover a signal representing a composite of PRN sequences from one or more US sources. Ultrasonic signal sampling unit 520 may perform the correlation of the composite signal of the PRN sequences with different code phases of the PRN sequence as decoded from the WiFi beacon data by demodulate/decode module 510 to search for the US signal modulated with the decoded PRN sequence. A detection of US signal may be declared when a correlation sum from one of the code phases exceeds an US detection threshold.

An ultrasonic signal D/A module 522 modulates an US signal with the PRN sequence of the device to generate a PRN-modulated US signal. The modulation may be performed in the digital domain and converted by a DAC (digital-to-analog converter) in ultrasonic signal D/A module 522 to generate the US signal for transmission by speaker 518 of the US transducer.

It is also contemplated that various embodiments provided by the present disclosure and/or the methods identified herein may be implemented using hardware, firmware, software, or any combinations thereof. For example, encode/modulate module 508, demodulate/decode module 510, and/or RSSI measurement module 512 of the device of FIG. 5 may be implemented by one or more processors, including but not limited to processor 514, and/or other processing components internal or external to the device. The processors may include a micro-controller, digital signal processor (DSP), or other processing components. The processors may perform specific operations by executing one or more sequences of instructions contained in a system memory. Logic may be encoded in a computer readable medium, which may refer to any medium that participates in providing instructions to processors for execution. Such a medium may take many forms, including but not limited to, non-volatile media, volatile media, and transmission media. In one embodiment, logic is encoded in non-transitory computer readable medium. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, although position or range estimation systems are illustrated using WiFi-enabled devices with US capabilities, embodiments of the present disclosure may encompass devices having any communication technologies, including other wireless and wire-line communication systems. Furthermore, ranging measurements may be aided with transducers operating in frequency bands other than the US frequency. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method comprising:
transmitting a first WiFi signal from a first device;
transmitting a first ultrasonic (US) signal from the first device, wherein the first US signal is synchronized with the first WiFi signal;
receiving by the first device a second WiFi signal from a second device;
receiving by the first device a second US signal from the second device using information from the second WiFi signal, wherein the second US signal is generated in response to the first US signal; and
determining a range between the first device and the second device based on said transmitting of the first US signal, said receiving of the second US signal, and said receiving of the second WiFi signal.

2. The method of claim 1, wherein the first US signal is modulated with a PRN (pseudo random noise) sequence unique to the first device.

3. The method of claim 2, wherein the first WiFi signal comprises a beacon signal, and wherein said transmitting a first WiFi signal comprises transmitting the beacon signal to contain the PRN sequence unique to the first device.

4. The method of claim 1, wherein the second US signal is modulated with a PRN (pseudo random noise) sequence unique to the second device.

5. The method of claim 4, wherein the second WiFi signal comprises a beacon signal, wherein the beacon signal contains the PRN sequence unique to the second device.

6. The method of claim 5, wherein said receiving by the first device a second WiFi signal comprises demodulating the beacon signal to recover the PRN sequence unique to the second device.

7. The method of claim 5, wherein said receiving by the first device a second US signal using information from the second WiFi signal comprises correlating the second US signal with a plurality of code phases of the PRN sequence unique to the second device to detect the second US signal.

8. The method of claim 1, further comprising:
transmitting a request frame from the first device;
receiving an acknowledgement frame by the first device from the second device, wherein the acknowledgement frame is generated in response to the request frame after a delay from the second device; and
estimating by the first device a WiFi-based round-trip time (RTT) between said transmitting of the request frame and said receiving of the acknowledgement frame.

9. The method of claim 8, wherein said determining the range between the first device and the second device further comprises:
calibrating the delay using the US-based RTT.

10. The method of claim 1, further comprising:
receiving by the first device a position of a third device and a range between the third device and the second device; and
computing a position of the second device from the range between the first device and the second device, the range between the third device and the second device, a position of the first device and the position of the third device.

11. A method comprising:
receiving from a first device by a second device a first ultrasonic (US) signal, wherein the first US signal is modulated with a PRN (pseudo random noise) sequence unique to the first device;
receiving by the second device a first WiFi signal from the first device, wherein a transmission of the first WiFi signal is synchronized with a transmission of the first US signal from the first device;
estimating by the second device a time delay between said receiving of the first WiFi signal and said receiving of the first US signal; and
determining a range between the first device and the second device based on the time delay.

12. The method of claim 11, wherein the first WiFi signal comprises a beacon signal, wherein the beacon signal contains the PRN sequence unique to the first device.

13. The method of claim 12, wherein said receiving by the second device a first WiFi signal comprises demodulating the beacon signal to recover the PRN sequence unique to the first device.

14. The method of claim 11, wherein said receiving by the second device a first US signal comprises correlating the first US signal with a plurality of code phases of the PRN sequence unique to the first device to detect the first US signal.

15. The method of claim 11, further comprising:
receiving from a third device by the second device a second US signal, wherein the second US signal is modulated with a PRN sequence unique to the third device;
receiving by the second device a second WiFi signal from the third device, wherein the second WiFi signal is synchronized with the second US signal;
estimating by the second device a time delay between said receiving of the second WiFi signal and said receiving of the second US signal; and
determining a range between the third device and the second device based on the time delay between said receiving of the second WiFi signal and said receiving of the second US signal.

16. The method of claim 15, further comprising computing a position of the second device from the range between the first device and the second device, the range between the third device and the second device, and positions of the first device and the third device.

17. The method of claim 11, further comprising:
transmitting a second US signal from the second device to the first device, wherein the second US signal is modulated with a PRN sequence unique to the second device; and
transmitting a second WiFi signal from the second device to the first device, wherein the second WiFi signal is synchronized with the second US signal.

18. The method of claim 17, wherein the second WiFi signal comprises a beacon signal, wherein said transmitting a second WiFi signal comprises transmitting the beacon signal to contain the PRN sequence unique to the second device.

19. An apparatus, comprising:
a radio-frequency (RF) transceiver configured to transmit and receive WiFi signals;
an ultrasonic (US) transducer configured to transmit and receive US signals;
a non-transitory memory storing a plurality of machine-readable instructions; and
one or more processors coupled to the memory and operable to read the instructions from the memory to perform the steps of:
transmitting by the RF transceiver a first WiFi signal;
transmitting by the US transducer a first US signal, wherein the first US signal is synchronized with the first WiFi signal;
receiving by the RF transceiver a second WiFi signal from a first device;
receiving by the US transducer a second US signal from the first device, wherein the second US signal is generated in response to the first US signal;
detecting the second US signal using information from the second WiFi signal; and
determining a range between the apparatus and the first device based on said transmitting of the first US signal, said detecting of the second US signal, and said receiving of the second WiFi signal.

20. The apparatus of claim 19, further comprising a modulator configured to modulate the first US signal with a PRN (pseudo random noise) sequence unique to the apparatus.

21. The apparatus of claim 20, wherein the first WiFi signal comprises a beacon signal, and wherein said transmitting a first WiFi signal comprises transmitting the beacon signal to contain the PRN sequence unique to the apparatus.

22. The apparatus of claim 19, wherein the second US signal is modulated with a PRN (pseudo random noise) sequence unique to the first device.

23. The apparatus of claim 22, wherein the second WiFi signal comprises a beacon signal, wherein the beacon signal contains the PRN sequence unique to the first device.

24. The apparatus of claim 23, further comprising a demodulator configured to demodulate the beacon signal to recover the PRN sequence unique to the first device.

25. The apparatus of claim 23, wherein said detecting the second US signal using information from the second WiFi signal comprises correlating the second US signal with a plurality of code phases of the PRN sequence unique to the first device to detect the second US signal.

26. The apparatus of claim 19, wherein the one or more processors are operable to read the instructions from the memory to further perform the steps of:
transmitting by the RF transceiver a request frame;
receiving by the RF transceiver an acknowledgement frame from the first device, wherein the acknowledgement frame is generated in response to the request frame after a delay from the first device; and
estimating a WiFi-based round-trip time (RTT) between said transmitting of the request frame and said receiving of the acknowledgement frame.

27. The apparatus of claim 26, wherein said determining the range between the apparatus and the first device further comprises:
calibrating the delay using the US-based RTT.

28. The apparatus of claim 19, wherein the one or more processors are operable to read the instructions from the memory to further perform the steps of:
receiving by the RF transceiver a position of a second device and a range between the second device and the first device; and
computing a position of the first device from the range between the apparatus and the first device, the range between the second device and the first device, a position of the apparatus, and the position of the second device.

29. An apparatus, comprising:
a radio-frequency (RF) transceiver configured to transmit and receive WiFi signals;
an ultrasonic (US) transducer configured to transmit and receive US signals;
a non-transitory memory storing a plurality of machine-readable instructions; and
one or more processors coupled to the memory and operable to read the instructions from the memory to perform the steps of:
receiving by the US transducer a first ultrasonic (US) signal from a first device, wherein the first US signal is modulated with a PRN (pseudo random noise) sequence unique to the first device;
receiving by the RF transceiver a first WiFi signal from the first device, wherein a transmission of the first WiFi signal is synchronized with a transmission of the first US signal from the first device;
estimating a time delay between said receiving of the first WiFi signal and said receiving of the first US signal; and
determining a range between the first device and the apparatus based on the time delay.

30. The apparatus of claim 29, wherein the first WiFi signal comprises a beacon signal, wherein the beacon signal contains the PRN sequence unique to the first device.

31. The apparatus of claim 30, further comprising a demodulator configured to demodulate the beacon signal to recover the PRN sequence unique to the first device.

32. The apparatus of claim 29, wherein the one or more processors are operable to read the instructions from the memory to further perform the step of:
correlating the first US signal with a plurality of code phases of the PRN sequence unique to the first device to detect the first US signal.

33. The apparatus of claim 29, wherein the one or more processors are operable to read the instructions from the memory to further perform the steps of:
receiving by the RF transceiver a second US signal from a second device, wherein the second US signal is modulated with a PRN sequence unique to the second device;
receiving by the RF transceiver a second WiFi signal from the second device, wherein the second WiFi signal is synchronized with the second US signal;
estimating a time delay between said receiving of the second WiFi signal and said receiving of the second US signal; and
determining a range between the second device and the apparatus based on the time delay between said receiving of the second WiFi signal and said receiving of the second US signal.

34. The apparatus of claim 33, wherein the one or more processors are operable to read the instructions from the memory to further perform the step of:
computing a position of the apparatus from the range between the first device and the apparatus, the range between the second device and the apparatus, and positions of the first device and the second device.

35. The apparatus of claim 29, wherein the one or more processors are operable to read the instructions from the memory to further perform the steps of:
transmitting by the RF transceiver a second US signal to the first device, wherein the second US signal is modulated with a PRN sequence unique to the apparatus; and
transmitting by the RF transceiver a second WiFi signal to the first device, wherein the second WiFi signal is synchronized with the second US signal.

36. The apparatus of claim 35, wherein the second WiFi signal comprises a beacon signal, wherein said transmitting by the RF transceiver the second WiFi signal comprises transmitting the beacon signal to contain the PRN sequence unique to the apparatus.

37. A system comprising:
means for transmitting a first WiFi signal;
means for transmitting a first ultrasonic (US) signal, wherein the first US signal is synchronized with the first WiFi signal;
means for receiving a second WiFi signal from a first device;
means for receiving a second US signal from the first device using information from the second WiFi signal, wherein the second US signal is generated in response to the first US signal; and
means for determining a range between the system and the first device based on said transmitting of the first US signal, said receiving of the second US signal, and said receiving of the second WiFi signal.

38. The system of claim 37, further comprising means for modulating the first US signal with a PRN (pseudo random noise) sequence unique to the system.

39. The system of claim 38, wherein the first WiFi signal comprises a beacon signal, and wherein the means for transmitting a first WiFi signal comprises means for transmitting the beacon signal to contain the PRN sequence unique to the system.

40. The system of claim 37, wherein the second US signal is modulated with a PRN (pseudo random noise) sequence unique to the first device.

41. The system of claim 40, wherein second WiFi signal comprises a beacon signal, wherein the beacon signal contains the PRN sequence unique to the first device.

42. The system of claim 41, further comprising means for demodulating the beacon signal to recover the PRN sequence unique to the first device.

43. The system of claim 41, wherein the means for receiving a second US signal from the first device using information from the second WiFi signal comprises means for correlating the second US signal with a plurality of code phases of the PRN sequence unique to the first device to detect the second US signal.

44. The system of claim 37, further comprising:
means for transmitting a request frame;
means for receiving an acknowledgement frame from the first device, wherein the acknowledgement frame is generated in response to the request frame after a delay from the first device; and
means for estimating a WiFi-based round-trip time (RTT) between said transmitting of the request frame and said receiving of the acknowledgement frame.

45. The system of claim 44, wherein the means for determining a range between the system and the first device comprises means for calibrating the delay using the US-based RTT.

46. The system of claim 37, further comprising:
means for receiving a position of a second device and a range between the second device and the first device; and
means for computing a position of the first device from the range between the system and the first device, the range between the second device and the first device, a position of the system, and the position of the second device.

47. A system comprising:
means for receiving a first ultrasonic (US) signal from a first device, wherein the first US signal is modulated with a PRN (pseudo random noise) sequence unique to the first device;
means for receiving a first WiFi signal from the first device, wherein a transmission of the first WiFi signal is synchronized with a transmission of the first US signal from the first device;
means for estimating a time delay between said receiving of the first WiFi signal and said receiving of the first US signal; and
means determining a range between the first device and the system based on the time delay.

48. The system of claim 47, wherein the first WiFi signal comprises a beacon signal, wherein the beacon signal contains the PRN sequence unique to the first device.

49. The system of claim 48, further comprising means for demodulating the beacon signal to recover the PRN sequence unique to the first device.

50. The system of claim 47, further comprising means for correlating the first US signal with a plurality of code phases of the PRN sequence unique to the first device to detect the first US signal.

51. The system of claim 47, further comprising:
means for receiving a second US signal from a second device, wherein the second US signal is modulated with a PRN sequence unique to the second device;
means for receiving a second WiFi signal from the second device, wherein the second WiFi signal is synchronized with the second US signal;
means for estimating a time delay between said receiving of the second WiFi signal and said receiving of the second US signal; and
means for determining a range between the second device and the system based on the time delay between said receiving of the second WiFi signal and said receiving of the second US signal.

52. The system of claim 51, further comprising means for computing a position of the system from the range between first device and the system, the range between the second device and the system, and positions of the first device and the second device.

53. The system of claim 47, further comprising:
means for transmitting a second US signal to the first device, wherein the second US signal is modulated with a PRN sequence unique to the system; and
means for transmitting a second WiFi signal to the first device, wherein the second WiFi signal is synchronized with the second US signal.

54. The system of claim 53, wherein the second WiFi signal comprises a beacon signal, wherein the means for transmitting the second WiFi signal comprises means for transmitting the beacon signal to contain the PRN sequence unique to the system.

55. A non-transitory computer-readable medium comprising a plurality of machine-readable instructions which, when executed by one or more processors, are adapted to cause the one or more processors to perform a method comprising:
transmitting a first WiFi signal from a first device;
transmitting a first ultrasonic (US) signal from the first device, wherein the first US signal is synchronized with the first WiFi signal;
receiving by the first device a second WiFi signal from a second device;
receiving by the first device a second US signal from the second device using information from the second WiFi signal, wherein the second US signal is generated in response to the first US signal; and
determining a range between the first device and the second device based on said transmitting of the first US signal, said receiving of the second US signal, and said receiving of the second WiFi signal.

56. The non-transitory computer-readable medium of claim 55, wherein the first US signal is modulated with a PRN (pseudo random noise) sequence unique to the first device.

57. The non-transitory computer-readable medium of claim 56, wherein the first WiFi signal comprises a beacon signal, and wherein said transmitting a first WiFi signal comprises transmitting the beacon signal to contain the PRN sequence unique to the first device.

58. The non-transitory computer-readable medium of claim 55, wherein the second US signal is modulated with a PRN (pseudo random noise) sequence unique to the second device.

59. The non-transitory computer-readable medium of claim 58, wherein the second WiFi signal comprises a beacon signal, wherein the beacon signal contains the PRN sequence unique to the second device.

60. The non-transitory computer-readable medium of claim 59, wherein said receiving by the first device a second WiFi signal comprises demodulating the beacon signal to recover the PRN sequence unique to the second device.

61. The non-transitory computer-readable medium of claim 59, wherein said receiving by the first device a second US signal using information from the second WiFi signal comprises correlating the second US signal with a plurality of code phases of the PRN sequence unique to the second device to detect the second US signal.

62. The non-transitory computer-readable medium of claim 55, wherein the method further comprises:
transmitting a request frame from the first device;
receiving an acknowledgement frame by the first device from the second device, wherein the acknowledgement frame is generated in response to the request frame after a delay from the second device; and
estimating by the first device a WiFi-based round-trip time (RTT) between said transmitting of the request frame and said receiving of the acknowledgement frame.

63. The non-transitory computer-readable medium of claim 62, wherein said determining the range between the first device and the second device further comprises:
calibrating the delay using the US-based RTT.

64. The non-transitory computer-readable medium of claim 55, wherein the method further comprises:
receiving by the first device a position of a third device and a range between the third device and the second device; and
computing a position of the second device from the range between the first device and the second device, the range between the third device and the second device, a position of the first device and the position of the third device.

65. A non-transitory computer-readable medium comprising a plurality of machine-readable instructions which, when executed by one or more processors, are adapted to cause the one or more processors to perform a method comprising:
receiving from a first device by a second device a first ultrasonic (US) signal, wherein the first US signal is modulated with a PRN (pseudo random noise) sequence unique to the first device;
receiving by the second device a first WiFi signal from the first device, wherein a transmission of the first WiFi signal is synchronized with a transmission of the first US signal from the first device;
estimating by the second device a time delay between said receiving of the first WiFi signal and said receiving of the first US signal; and
determining a range between the first device and the second device based on the time delay.

66. The non-transitory computer-readable medium of claim 65, wherein the first WiFi signal comprises a beacon signal, wherein the beacon signal contains the PRN sequence unique to the first device.

67. The non-transitory computer-readable medium of claim 66, wherein said receiving by the second device a first WiFi signal comprises demodulating the beacon signal to recover the PRN sequence unique to the first device.

68. The non-transitory computer-readable medium of claim 65, wherein said receiving by the second device a first US signal comprises correlating the first US signal with a plurality of code phases of the PRN sequence unique to the first device to detect the first US signal.

69. The non-transitory computer-readable medium of claim 65, wherein the method further comprises:
receiving from a third device by the second device a second US signal, wherein the second US signal is modulated with a PRN sequence unique to the third device;
receiving by the second device a second WiFi signal from the third device, wherein the second WiFi signal is synchronized with the second US signal;
estimating by the second device a time delay between said receiving of the second WiFi signal and said receiving of the second US signal; and
determining a range between the third device and the second device based on the time delay between said receiving of the second WiFi signal and said receiving of the second US signal.

70. The non-transitory computer-readable medium of claim 69, wherein the method further comprises computing a position of the second device from the range between the first device and the second device, the range between the third device and the second device, and positions of the first device and the third device.

71. The non-transitory computer-readable medium of claim 65, wherein the method further comprises:
transmitting a second US signal from the second device to the first device, wherein the second US signal is modulated with a PRN sequence unique to the second device; and
transmitting a second WiFi signal from the second device to the first device, wherein the second WiFi signal is synchronized with the second US signal.

72. The non-transitory computer-readable medium of claim 71, wherein the second WiFi signal comprises a beacon signal, wherein said transmitting a second WiFi signal comprises transmitting the beacon signal to contain the PRN sequence unique to the second device
